(19) United States
(12) Patent Application Publication
(10) Pub. No.: US 2007/0013807 A1
(43) Pub. Date: Jan. 18, 2007

(54) DIGITAL CAMERA

(76) Inventors: Kunihiko Kanai, Nagano (JP); Shuji Asami, Shizuoka (JP); Masao Kobayashi, Nagano (JP)

Correspondence Address: PATENT LEGAL STAFF, EASTMAN KODAK COMPANY, 343 STATE STREET, ROCHESTER, NY, 14650-2201, US

(21) Appl. No.: 11/383,967

(22) Filed: May 18, 2006

(30) Foreign Application Priority Data
Jul. 14, 2005 (JP) 2005-205360

(51) Int. Cl. H04N 5/235

(52) U.S. Cl. 348/362

(57) ABSTRACT

To provide a camera which enables photographing while intentionally, subtly shifting operation timing from that of another camera. A digital camera has a timing computing circuit. The timing computing circuit receives a reset request from another digital camera by way of a communications interface. The timing computing circuit awaits a reset request for a standby period shown by the reset request, and outputs a reset command to a reset circuit. The reset circuit outputs a reset signal to a timing generator (TG) in accordance with the reset command.

### FIELD OF THE INVENTION

The present invention relates to a digital camera which performs photographing operation in cooperation with another digital camera connected to the digital camera by way of a network.

### BACKGROUND OF THE INVENTION

A photographing system utilizing a plurality of cameras includes, e.g., a system which displays images captured by a plurality of cameras on a multi-screen; a system for generating a three-dimensional image of a subject; a system for measuring a distance to a subject; and a system for generating a wide-range image, such as a panoramic image. In such a photographing system, a plurality of cameras must be synchronized.

In relation to the photographing system such as that mentioned above, a technique for synchronizing a plurality of cameras is described in U.S. Published Application Publication 2002/0135682 to Oka et al. According to Oka et al, a master camera generates a time stamp used for synchronizing frame synchronization signals of all cameras (including the master camera). All the cameras generate frame synchronization signals on the basis of the time stamp generated by the master camera, to thus synchronize the plurality of cameras.

By way of the technique described in Oka et al, the plurality of cameras can be synchronized. However, difficulty is encountered in causing cameras to perform photographing while intentionally, subtly shifting operation timing from one camera to another camera, by way of merely synchronizing a plurality of cameras; for instance, a slave camera starting performing exposure immediately after a master camera has completed exposure to thus perform continuous photographing of a single subject while eliminating a blank period during which a single subject is not exposed.

### SUMMARY OF THE INVENTION

Accordingly, the present invention provides a camera which enables photographing while intentionally, subtly shifting operation timing from that of another camera.

The present invention provides a digital camera for performing photographing in cooperation with another digital camera connected thereto by way of a network, the camera comprising:

an image sensor;

a timing generator for outputting a vertical synchronization signal to the image sensor;

a reset circuit for outputting to the timing generator a reset signal used for resetting output timing of the vertical synchronization signal;

a communications interface for receiving a reset request from the other digital camera;

a reset control circuit which acquires a standby period from when the reset request has been received until when the reset circuit outputs a reset signal and controls the reset circuit so as to output a reset signal after having waited the acquired standby period; and

a sensor control circuit for controlling the image sensor so as to start performing exposure in synchronism with the reset vertical synchronization signal. The standby period is determined on the basis of a photographing parameter of the digital camera or that of the other digital camera

According to the present invention, upon receipt of a reset request, the digital camera resets a vertical synchronization signal after having waited for a standby period which is determined by a photographing parameter. Thereby, the digital camera can shift output timing of a vertical synchronization signal from a timing at which another digital camera outputs a vertical synchronization signal, by a time corresponding to the photographing parameter. Accordingly, the digital camera can perform photographing while subtly shifting operation timing from that of another digital camera according to the photographing parameter.

The invention will be more clearly comprehended by reference to the embodiments provided below. However, the scope of the invention is not limited to those embodiments.

### BRIEF DESCRIPTION OF THE DRAWINGS

Preferred embodiments of the present invention will be described in detail based on the following figures, wherein:

FIG. 1 is a view showing a schematic configuration of a photographic system according to an embodiment of the present invention;

FIG. 2 is a view showing functional blocks of a camera in the photographic system;

FIG. 3 is a timing chart acquired when a master camera and a slave camera perform photographing in a continuous exposure mode;

FIG. 4A is a flowchart showing photographing procedures of the master camera;

FIG. 4B is a flowchart showing photographing procedures of the slave camera;

FIG. 5 is a timing chart acquired when the master camera and the slave camera perform photographing in a first synchronous mode;

FIG. 6 is a timing chart acquired when the master camera and the slave camera perform photographing in a second synchronous mode;

FIG. 7 is a timing chart acquired when the master camera and a plurality of slave cameras perform continuous exposure during a single exposure period;

FIG. 8 is a timing chart acquired when the master camera and the plurality of slave cameras perform continuous exposure during different exposure periods; and

FIG. 9 is a timing chart acquired when the master camera and the plurality of slave cameras perform photographing at the same photographing interval.

### DETAILED DESCRIPTION OF THE PREFERRED EMBODIMENT

The best mode for carrying out the present invention (hereinafter called an “embodiment”) will be described hereinbelow by reference to the drawings.

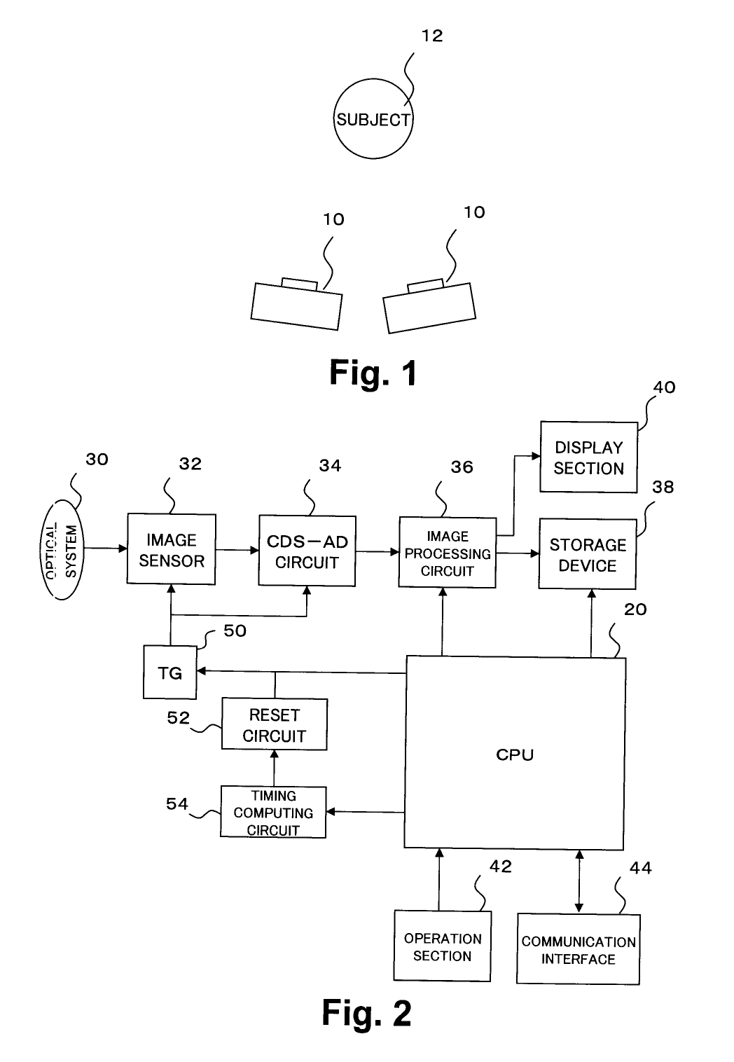

FIG. 1 is a view showing the schematic configuration of a photographing system according to an embodiment of the present invention. As shown in FIG. 1, the present system includes two digital cameras 10 (hereinafter simply called “cameras 10”). Each camera 10 can operate in two modes; i.e., a master mode and a slave mode. In the present embodiment, a camera set to a slave mode (hereinafter called a “slave camera”) controls output timing of a vertical synchronization signal in accordance with a command from a camera set to the master mode (hereinafter called a “master camera”). Each of the cameras 10 can operate in a plurality of photographing modes. Each of the cameras 10 controls output timing of a vertical synchronization signal in accordance with a photographing mode selected by the user, and the respective cameras 10 photograph a subject 12 in cooperation with each other and in accordance with the controlled vertical synchronization signal. The term “photographing mode” used herein signifies operation procedures which specify exposure timing and timing of firing a flash for each camera 10 in such a way that a desired photograph is acquired. A specific example of photographing mode will be described later.

FIG. 2 is a view showing functional blocks of each of the cameras 10 constituting the present photographing system. In FIG. 2, a CPU 20 is a central processing unit which controls the overall camera 10, and performs arithmetic processing operations and control of respective circuits, or the like, which constitute the camera 10. An optical system 30 includes a lens and a diaphragm which are used for allowing light from the subject enter an image sensor 32 such that a desired image signal is obtained.

The image sensor 32 converts incident light into signal charges through photoelectric conversion performed by a light-receiving element array, and outputs the signal charges. The light-receiving element array of the image sensor 32 is formed from L(vertical)×N(horizontal) (L, N are integers) pixels to which R (red), G (green), and B (blue) color filters are affixed. The image signal output from the image sensor 32 has RGB components. The image sensor 32 is activated in a preview mode, where a simplified image signal for monitoring purpose including some pixels—into which a vertical image has been diminished to 1/1 (“1” is an integer)—is output, and a still mode where an image signal for recording purpose, including all pixels, is output.

A CDS (Correlated Double Sampling)-AD (Analog/Digital) circuit 34 reduces noise in the image signal output from the image sensor 32 by way of correlated double sampling to thereby convert the image signal into a digital signal. An image-processing circuit 36 subjects the image signal output from the CDS-AD circuit 34 to predetermined image processing. A storage device 38 saves, as image data, a video signal for recording purpose which has been subjected to predetermined image processing by way of the image-processing circuit 36. For monitoring purpose, a display section 40 displays on a screen a motion picture based on the simplified image signal.

An operation section 42 is a user interface used by the user to operate the camera 10, such as a shutter button which can be pressed halfway down or all the way down. A communications interface 44 controls communication with another camera 10 by way of radio communication such as WiFi or wire communication.

A timing generator (TG) 50 outputs a horizontal synchronization signal (HD) and a vertical synchronization signal (VD), which are required to control the light-receiving element array included in the image sensor 32, as well as outputting a synchronization signal required by the CDS-AD circuit 34 to perform signal processing, thereby synchronizing the image sensor 32 and the CDS-AD circuit 34. A reset circuit 52 outputs a reset signal to the timing generator 50. By way of the input reset signal, the timing generator 50 controls output timings of the respective synchronization signals. More specifically, the reset circuit 52 temporarily switches a reference pulse, which is output from an oscillator circuit (not shown) to the timing generator 50, from High to Low, and further switches from Low to High at another predetermined timing. The timing when the reset circuit 53 switches the reference pulse from Low to High corresponds to a timing when the reset signal is output. As mentioned above, the reset circuit 52 controls output timings of the respective synchronization signals output by the timing generator 50, by way of switching of the reference pulse between Low and High.

A timing-computing circuit 54 outputs to the reset circuit 52 a reset command used for commanding output of a reset signal. When outputting a reset command, the timing-computing circuit (hereinafter called a “timing-computing circuit [M],” and the same also applies to other circuits and the like) of the master camera transmits a reset request for requesting the slave camera to output a reset signal. The reset request shows a standby period T_{W} starting from receipt of the request by the timing-computing circuit (hereinafter called a “timing-computing circuit [S],” and the same also applies to other circuits and the like) of the slave camera and ending with output of a reset command is. Specifically, upon receipt of a reset request, the timing-computing circuit [S] outputs a reset command to the reset circuit [S] after having waited during the standby period T_{W} shown in the request. The synchronization signal output from the timing generator [M] and the synchronization signal output from the timing generator [S] are shifted from each other by a period corresponding to the standby period T_{W}.

In the present photographing system, the method for computing a standby period T_{W}, which is computed by the timing-computing circuit 54, is changed according to the photographing mode. Thereby, the synchronization signal (the vertical synchronization signal) is intentionally shifted for each camera 10, to thus shift an exposure period.

The method for computing the standby period T_{W} will now be described by way of taking a continuous exposure mode, which is one of the photographing modes, as an example. In the present embodiment, the continuous exposure mode signifies a photographing mode where a slave camera starts performing exposure immediately after the master camera has completed exposure to thus perform continuous exposure of a single subject while eliminating a blank period during which exposure is not carried out.

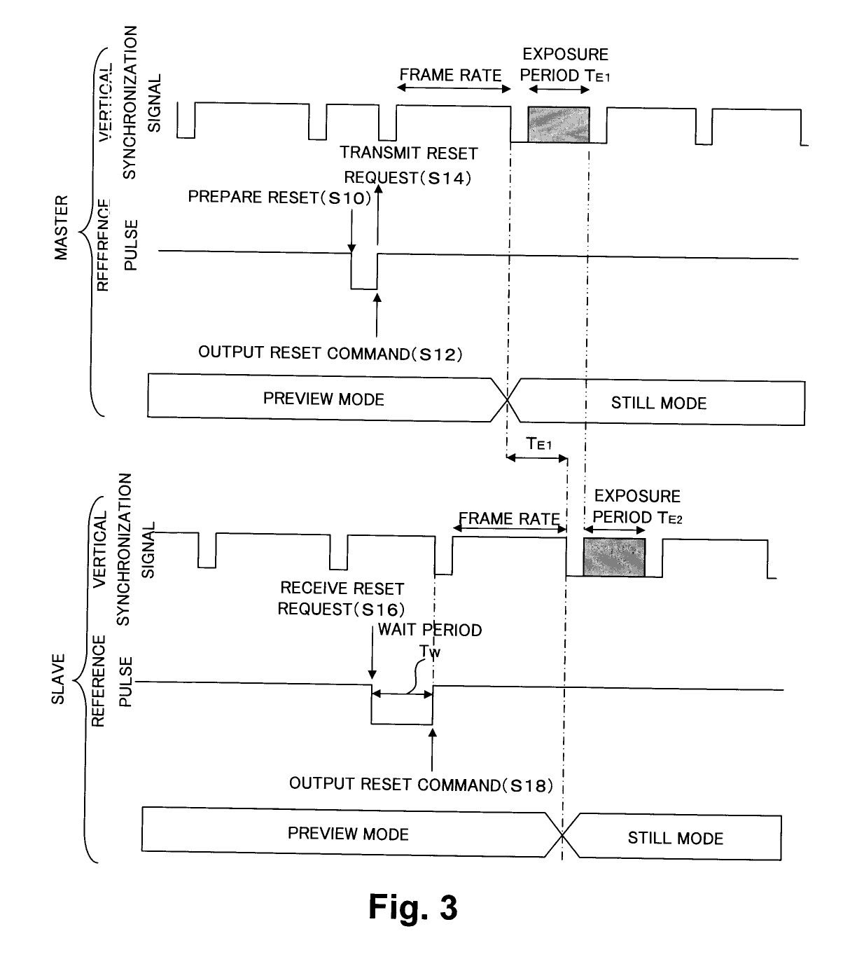

FIG. 3 is a view showing a timing chart acquired when the master camera and the slave camera perform photographing in the continuous exposure mode. In FIG. 3, the timing-computing circuit [M] first commands the reset circuit [M] to prepare resetting operation (S10), whereby the reference pulse [M] is switched from High to Low. Subsequently, the timing-computing circuit [M] outputs a reset command to the reset circuit [M] after having waited for a given period of time (S12), whereby the reference pulse [M] is switched from Low to High, and the output timing of the vertical synchronization signal [M] is reset. It is better to set a time, which is sufficient for switching the synchronization pulse [M] from Low to High, for the predetermined period. Simultaneously with outputting a reset command in S12, the timing-computing circuit [M] transmits to the timing-computing circuit [S] a reset request, which shows the standby period T_{W} (S14).

In the meantime, upon receipt of the reset request (S16), the timing-computing circuit [S] immediately commands the reset circuit [S] to prepare for resetting operation, whereby the reference pulse [S] is switched from High to Low. Subsequently, the timing-computing circuit [S] waits during the standby period T_{W} after having received the reset request, and outputs a reset command to the reset circuit [S] (S18). The reference pulse [S] is then switched from Low to High, whereby the output timing of the vertical synchronization signal [S] is reset.

When the reset vertical synchronization signal first turns into a negative polarity, each of the master and slave cameras switches the drive mode of the image sensor from the preview mode to the still mode, thereby initiating exposure. A single value, such as 30 fps (frames/sec.), is set as a cycle of the vertical synchronization signal (i.e., a frame rate) for the master camera and the slave camera in the preview mode. Consequently, the time from when the master camera has started exposure until the slave camera starts exposure can be controlled by way of controlling the time from when the master camera has reset the vertical synchronization signal until when the slave camera resets the vertical synchronization signal. In short, the timings at which the master camera and the slave camera start exposure can be controlled, by way of controlling the standby period T_{W}.

When the slave camera starts exposure immediately after the exposure period T_{E1} of the master camera has been completed, it is better, as can be seen from FIG. 3, to shift the timing at which the master camera outputs the vertical synchronization signal (hereinafter simply called a “V-sync signal output timing”) from the V-sync signal output timing of the slave camera, by the amount corresponding to the exposure period T_{E1}. Specifically, the period from when the master camera has reset the vertical synchronization signal until when the slave camera resets the vertical synchronization signal is taken as the exposure period T_{E1}. A communication time T_{D} is consumed from when the timing-computing circuit [M] has transmitted the reset request until when the timing-computing circuit [S] receives the reset request. Accordingly, the timing-computing circuit [M] computes the standby period T_{W} according to the following expression (1) in consideration of the communication time T_{D}, whereby the V-sync signal output timing of the master camera can be shifted from the V-sync signal output timing of the slave camera by the amount corresponding to the exposure period T_{E1}.
T_{W}=T_{E1}−T_{D} (1)

It is better to determine the communication time T_{D} on the basis of an actually-measured value obtained by means of actually measuring a time during which communication is established between the master camera and the slave camera.

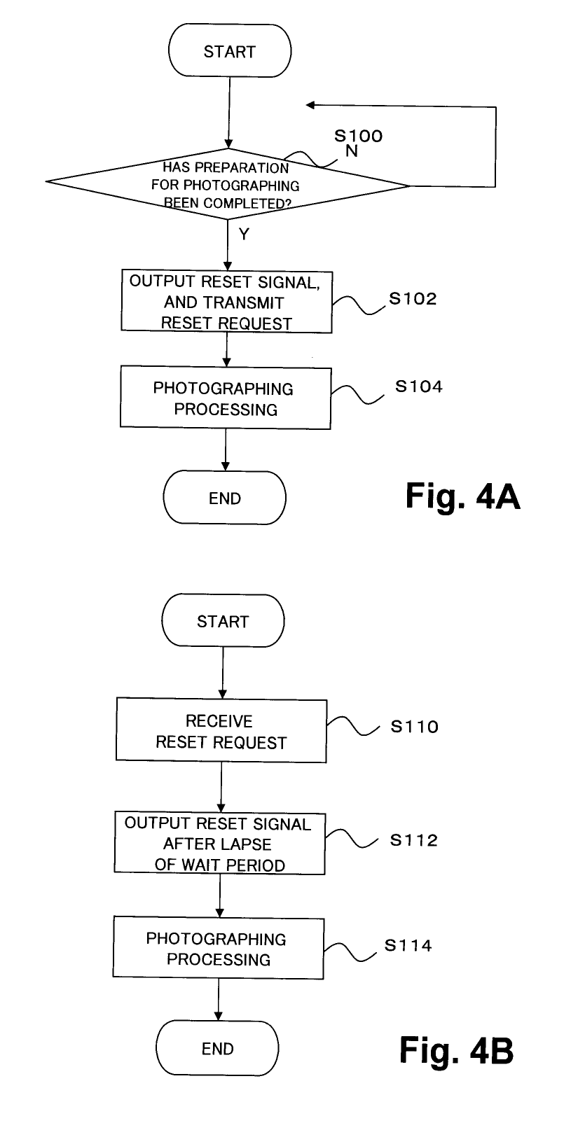

Next, photographing procedures of the master camera will be described by reference to a flowchart shown in FIG. 4A, and photographing procedures of the slave camera will be described by reference to a flowchart shown in FIG. 4B. The user performs operation in advance to set each of the cameras 10 into a master mode or a slave mode, and further sets the photographing mode of the camera 10. Moreover, the user places the respective cameras 10, for which various settings have been made, at predetermined positions.

In FIG. 4A, the master camera determines whether or not the preparation for photographing has been completed (S100). Specifically, the shutter button of the master camera is pressed halfway down, to thereby perform auto-focusing (AF) processing or auto-exposure (AE) processing. Thereby, the standby period T_{W} is computed after deriving photographing parameters required for photographing, such as a focal distance, an exposure period, firing/unfiring of a flash, and a period of firing of a flash. When computation of the standby period T_{W} has been completed and the shutter button has been pressed all the way down, the master camera determines completion of the preparation for photographing. When the preparation for photographing has been completed, the master camera resets the vertical synchronization signal by way of outputting a reset signal while transmitting a reset request, which shows the standby period T_{W}, to the slave camera (S102). Subsequently, the master camera performs photographing (S104).

In FIG. 4B, when having been set in the slave mode, the slave camera performs AF processing and AE processing and then enters a standby condition until it receives a reset request from the master camera. The slave camera may be caused to start AF processing and AE processing as a result of the user having pressed the shutter button halfway down as in the case of the master camera, to thus enter a standby condition. Upon receipt of a reset request from the master camera (S110), the slave camera in the standby condition outputs a reset signal after elapse of the standby period T_{W} indicated by the reset request, to thus reset the vertical synchronization signal (S112). Subsequently, the slave camera performs photographing (S114).

As above, according to the present embodiment, the respective cameras 10 perform exposure in accordance with the vertical synchronization signals whose output timings are shifted from one camera to another camera, so that photographing can be performed while the exposure periods are intentionally shifted.

The present embodiment has described the example where the master camera computes the standby period T_{W} in consideration of the exposure period T_{E1} of the master camera. The master camera may transmit the reset request, which shows the exposure period T_{E1}, to the slave cameras without computing the standby period T_{W}, and the slave camera may compute the standby period T_{W} by use of the exposure period T_{E1}. Further, if the master camera and the slave camera are given the same photographing conditions and the same exposure period, the slave camera may compute the standby period T_{W} on the basis of an exposure period T_{E2} of the slave camera. Specifically, when outputting the reset signal, the master camera transmits to the slave camera the reset request which does not show the standby period T_{W}. Upon receipt of the reset request, the slave camera waits during the standby period T_{W}, which is computed by the slave camera on the basis of the exposure period T_{E2} of the slave camera, and then outputs the reset signal. Thus, when the master camera and the slave camera perform photographing under the same photographing conditions, the slave camera may compute the standby period T_{W} on the basis of the exposure period T_{E2} of the slave camera.

Subsequently, there will be described a method for computing the standby period T_{W} in connection with the photographing mode, where the master camera and the slave camera perform photographing while sharing a single flash, while taking two modes (hereinafter called a “first synchronous mode” and a “second synchronous mode”) as examples.

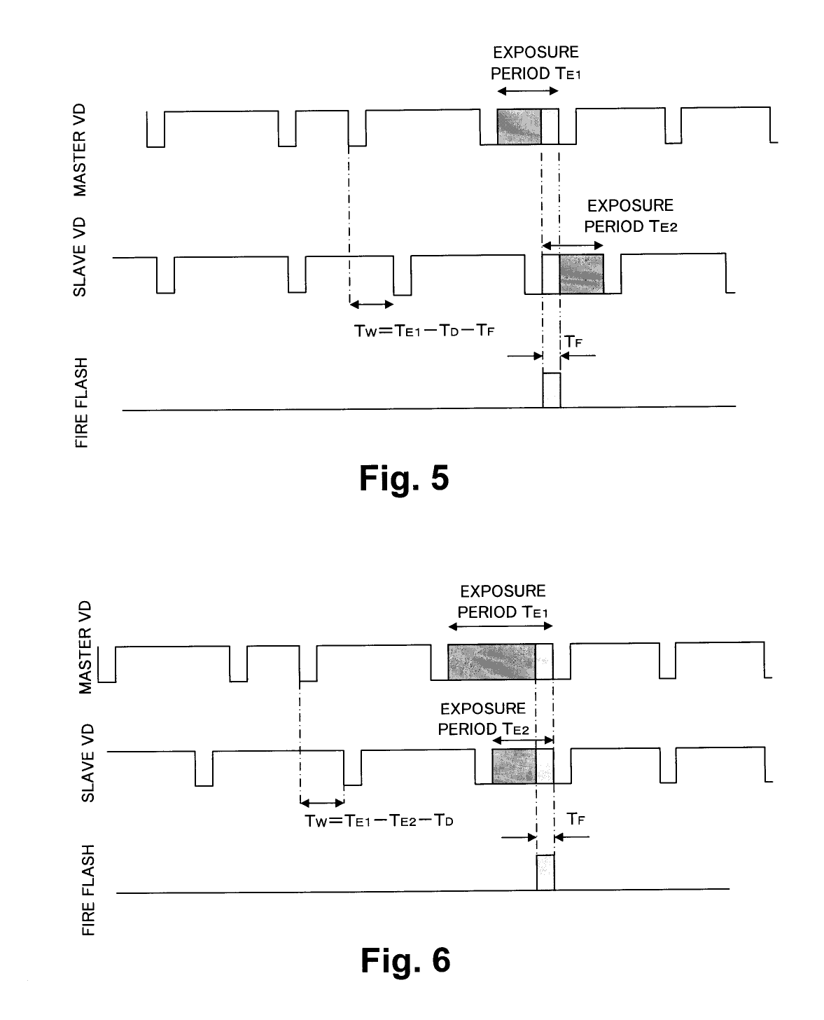

First, there will be described a method for computing the standby period T_{W} in the first synchronous mode. FIG. 5 shows a timing chart acquired when the master camera and the slave camera perform photographing in the first synchronous mode. As shown in FIG. 5, either the master camera or the slave camera fires a flash once in the first synchronous mode. The master camera performs photographing through so-called rear-curtain synchronization by firing a flash through. In contrast, the slave camera performs photographing through so-called front-curtain synchronization by firing a flash. Specifically, in the first synchronization mode, each of the cameras controls the firing timing of a flash so as to come immediately before completion of the exposure period of the master camera and immediately after the slave camera has started the exposure period. As shown in FIG. 5, in the first synchronization mode, the timing at which the slave camera outputs a reset signal is advanced ahead of the continuous exposure mode by an amount corresponding to a flash firing period R_{F}. Specifically, in the first synchronous mode, the slave camera waits, upon receipt of a reset request, during the standby period T_{W} computed according to the following equation (2), and outputs the reset signal.
T_{W}=T_{E1}−T_{D}−T_{F} (2)

When the master camera fires a flash, the master camera computes the standby period T_{W}, and transmits to the slave camera a reset request, which shows the standby period T_{W}. Alternatively, the master camera transmits to the slave camera a reset request, which shows the exposure period T_{E1}, and the flash firing period T_{F}, and the slave camera computes the standby period T_{W}. In the meantime, when the slave camera fires a flash, the master camera transmits to the slave camera a reset request, which shows the exposure period T_{E1} of the master camera. The slave camera computes the standby period T_{W} by use of the exposure period T_{E1} which is shown by the reset request.

As above, as a result of photographing being performed in the first synchronous mode, the image captured by the front-curtain synchronization and the image captured by the rear-curtain synchronization can be obtained by firing of a single flash.

There will now be described a method for computing the standby period T_{W} in the second synchronous mode. FIG. 6 shows a timing chart acquired when the master camera and the slave camera perform photographing in the second synchronous mode. As shown in FIG. 6, in the second synchronous mode the exposure period T_{E2} of the slave camera is made shorter than the exposure period T_{E1} of the master camera. By way of a single flash fired by the master camera or the slave camera, the master camera and the slave camera perform photographing in rear-curtain synchronization. In order to effect such photographing, the timing at which the slave camera outputs the reset signal is shifted from the timing at which the master camera outputs the reset signal, by the amount corresponding to a difference (T_{E1}−T_{E2}) between the exposure period T_{E1} of the master camera and the exposure period T_{E2} of the slave camera. In short, in the second synchronous mode, the slave camera is essentially required to wait for the standby period T_{W} computed according to the following equation (3) upon receipt of the reset request and output a reset signal.
T_{W}=T_{E1}−T_{E2}−T_{D} (3)

In the second synchronous mode, even when any of the cameras fires a flash, the timing-computing circuit [S] of the slave camera computes the standby period T_{W}.

As mentioned above, as a result of photographing being performed in the second synchronous mode, the images, which have been captured through two rear-curtain synchronization operations having different exposure periods, can be obtained by way of firing a single flash. For instance, when a night view, including a person, is photographed in the second synchronous mode, there can be acquired an image having different image quality in a distant view of a scene where no flash light reaches.

Subsequently, there will be described a method for computing the standby period T_{W} of each of the slave cameras in the continuous exposure mode when two or more slave cameras are present.

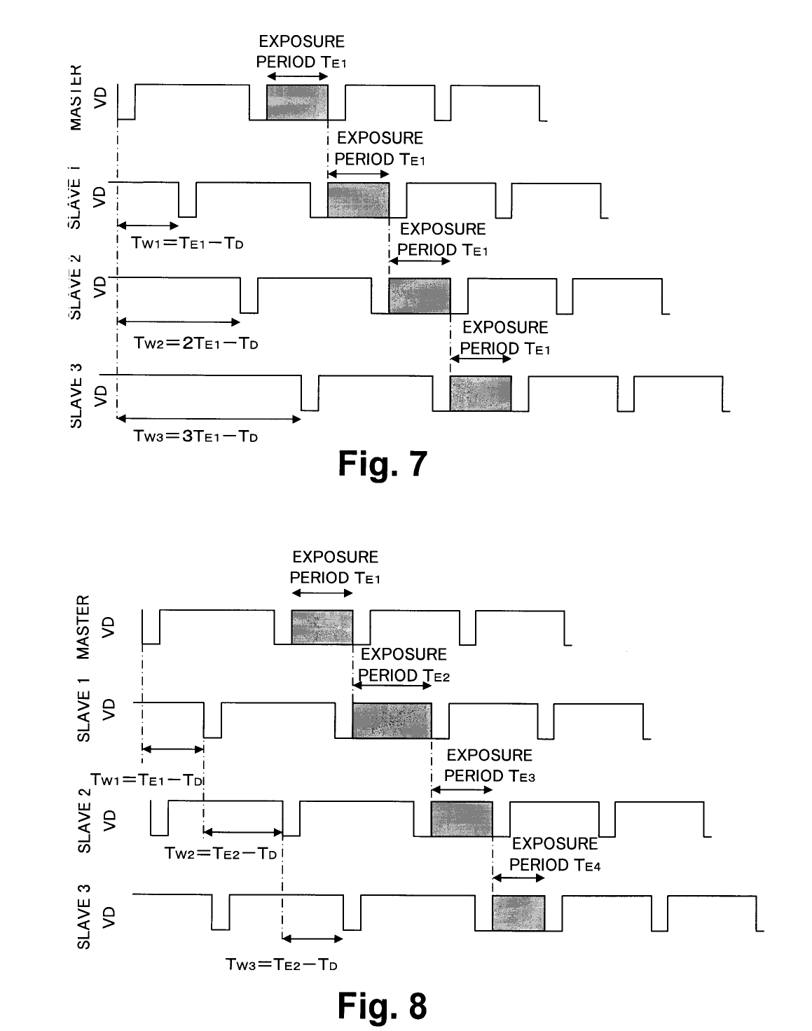

As shown in FIG. 7, when the respective cameras have the same exposure period and the cameras sequentially perform exposure, the standby period T_{Wn}, of the n^{th} slave camera can be computed according to the following equation (4).
T_{Wn}=n×T_{E1}−T_{D} (4)

In this case, for instance, the timing-computing circuit [M] of the master camera computes the standby period of each of the slave cameras according to Equation (4), and transmits to the respective slave cameras reset requests, which show the thus-computed respective standby periods. In this case, the master camera stores the sequence of the respective slave cameras in advance in association with identification information (e.g., an IP address) about the respective slave cameras.

As shown in FIG. 8, when the exposure periods of the respective cameras differ from each other, the master camera transmits to the first slave camera a reset request which shows a standby period computed according to Equation (1). In the meantime, each of the slave cameras computes a standby period for the next slave camera according to the following equation (5). Specifically, the slave camera subtracts the communication time T_{D} from the exposure period T_{En} thereof, to thus compute the standby period of the next slave camera. When outputting the reset signal, the slave camera transmits to the next slave camera the reset request, which shows the standby period.
T_{Wn}=T_{En-1}−T_{D} (5)

As above, even when exposure periods of the respective cameras differ from each other, continuous photographing, which does not have any blanks in an exposure period, can be realized by use of a plurality of cameras.

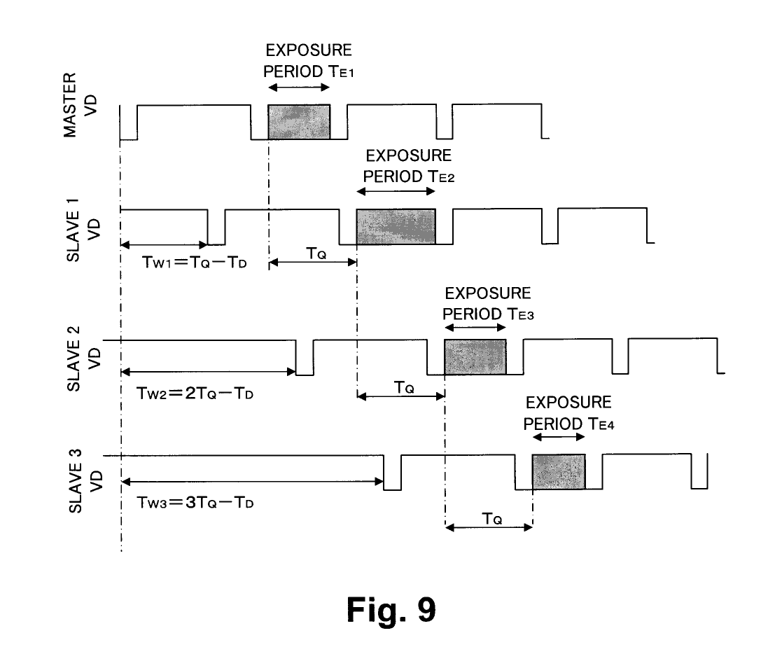

As shown in FIG. 9, even when exposure periods of the respective cameras differ from each other, the respective cameras can start photographing, where exposure is effected at a given interval provides a camera which enables photographing while intentionally, subtly shifting operation timing from that of another camera, in cooperation with each other, so long as the standby periods of the respective slave cameras can be computed according to the following equation (6).
T_{Wn}=n×T_{Q}−T_{D} (6)

An interval T_{Q} may be arbitrary. However, in the case of, for instance, a photographing time T_{M} and the number of cameras N, the interval may be computed from the following equation (7).
T_{Q}=T_{M}/N (7)

As above, according to the present embodiment, the standby period T_{W} from when each of the cameras has received a reset request until when the camera outputs a reset signal is changed according to the photographing mode, so that photographing can be performed while the output timing of the vertical synchronization signal can be intentionally, subtly shifted from one camera to another camera.

Provided that the camera, which is to become the master camera, outputs a reset request to the respective slave cameras in synchronism with a timing where the vertical synchronization signal changes to negative polarity in the preview mode, the master camera does not reset the vertical synchronization signal. Therefore, in this case, the master camera can shift the V-sync signal output timing of the slave camera for a desired period of time while maintaining the V-sync signal output timing acquired at this point in time.

The above descriptions have described the embodiment where the standby period T_{W} is computed in consideration of the communication time T_{D} to establish communication between the master camera and the slave cameras. However, so long as the master camera is configured to output a reset command after having waited for the communication time T_{D} since output of the reset request, the standby period T_{W} can be computed without subtracting the communication time T_{D}. So long as the communication time T_{D} is considerably shorter than the exposure period T_{E}, the standby period T_{W} may be computed without subtracting the communication time T_{D}. Further, when the communication time T_{D} is drastically shorter than the exposure period T_{E}, the standby period T_{W} may be computed without subtracting the communication time T_{D}.

Further, the above embodiment has described a case where the master camera and the slave cameras start performing exposure after the reset signal has been output. However, the master camera and the slave cameras can perform exposure at arbitrary timings after the vertical synchronization signal has been reset. Moreover, each of the cameras may start performing exposure by way of waiting again for a photographing start command after having reset the vertical synchronization signal.

The invention has been described in detail with particular reference to certain preferred embodiments thereof, but it will be understood that variations and modifications can be effected within the spirit and scope of the invention.

PARTS LIST

| | |
|---|---|
| 10 | camera |
| 12 | subject |
| 20 | CPU |
| 30 | optical system |
| 32 | image sensor |
| 34 | CDS-AD circuit |
| 36 | image-processing circuit |
| 42 | operation section |
| 38 | storage device |
| 44 | interface |
| 50 | timing generator |
| 52 | reset circuit |
| 53 | reset circuit |

1. A digital camera for performing photographing in cooperation with another digital camera connected thereto by way of a network, the camera comprising:
an image sensor;
a timing generator for outputting a vertical synchronization signal to the image sensor;
a reset circuit for outputting to the timing generator a reset signal used for resetting output timing of the vertical synchronization signal;
a communications interface for receiving a reset request from the other digital camera;
a reset control circuit for controlling the reset circuit so as to output a reset signal after having received the reset request and waited during a standby period which is determined on the basis of a photographing parameter of the digital camera or that of the other digital camera; and
a sensor control circuit for controlling the image sensor so as to start performing exposure in synchronism with the reset vertical synchronization signal.

2. The digital camera according to claim 1, wherein the reset control circuit transmits a reset request to the other digital camera by way of the communications interface when the reset circuit outputs a reset signal.

3. The digital camera according to claim 2, wherein the reset control circuit transmits the reset request while the reset request includes the photographing parameter of the digital camera.

4. The digital camera according to any one of claims 1 through 3, wherein the photographing parameter includes an exposure period employed when the digital camera or the other digital camera performs photographing.

5. The digital camera according to any one of claims 1 through 4, wherein the photographing parameter includes a flash firing period employed when the digital camera or the other digital camera performs photographing.

6. A digital camera for performing photographing in cooperation with another digital camera connected thereto by way of a network, the camera comprising:
an image sensor;
a timing generator for outputting a vertical synchronization signal to the image sensor;
a reset circuit for outputting to the timing generator a reset signal used for resetting output timing of the vertical synchronization signal; and
a reset control circuit for transmitting a reset request, which includes the photographing parameter of the digital camera, to the other digital camera when the reset circuit outputs a reset signal.
